(19) United States
(12) Patent Application Publication
(10) Pub. No.: US 2002/0021745 A1
(43) Pub. Date: Feb. 21, 2002

(54) Multi-channel-bandwidth frequency-hopping system

(76) Inventor: Kevin J. Negus, Hyattville, WY (US)

Correspondence Address: BURNS, DOANE, SWECKER & MATHIS, L.L.P., P.O. Box 1404, Alexandria, VA, 22313-1404, US

(21) Appl. No.: 09/828,267

(22) Filed: Apr. 6, 2001

Related U.S. Application Data
(60) Provisional application No. 60/195,639, filed on Apr. 7, 2000.

(51) Int. Cl. H04K 1/00; H04B 15/00; H04L 27/30

(52) U.S. Cl. 375/132; 375/133

(57) ABSTRACT

A multi-channel-bandwidth frequency-hopping system is described in which low bandwidth and high bandwidth hops are possible. There are more center frequencies available for low bandwidth hops than the high bandwidth hops. There are multiple possible center frequencies for low bandwidth hops within the same bandwidth range used for a single high bandwidth hop. By using more center frequencies for the low bandwidth hops than the high bandwidth hops, an improved system capacity, improved interference immunity, and backwards capacity with prior systems is provided.

### BACKGROUND OF THE PRESENT INVENTION

The present invention relates to frequency-hopping wireless communication systems. Frequency-hopping wireless communication systems are systems that transmit data using a center frequency with hops about a relatively broad frequency bandwidth. Unlike conventional systems in which a fixed-frequency carrier is used, in frequency-hopping systems, the carrier frequencies are approximately pseudo-randomly determined. Matched pseudo-random sequence generators at the transmitter and the receiver are used to synchronize and decode signals. For a given hop, the occupied transmission bandwidth in a conventional system is identical to the bandwidth of a conventional transmitter, much smaller than the total spread spectrum bandwidth. Averaged over many hops, however, the frequency hops occupy the entire spread spectrum bandwidth. Important advantages of this include immunity to interference as well as reducing the average power density of the transmitted signals so that they do not interfere with other devices.

One implementation of a wireless communication system is a wireless local area network (LAN) transmitting in a bandwidth allocated by the Federal Communications Commission (FCC) for such spread spectrum communications.

It is desired to have an improved frequency-hopping spread spectrum communication system.

### SUMMARY OF THE PRESENT INVENTION

The present invention is a system that at each hop can choose between a low and a high bandwidth signal. The invention is such that there are more center frequencies available for the use of the low bandwidth signals than by the high bandwidth signals. In a preferred embodiment, within a bandwidth range where there is only one possible high bandwidth center frequency, there are multiple possible low bandwidth center frequencies. The none of the low bandwidth signals extending outside of the bandwidth range of the high bandwidth signal.

This system provides better capacity than a system in which the low bandwidth hops would use the same center frequencies as the high bandwidth hops. Additionally, this system produces a better interference immunity for the system. Furthermore, there is an improved backward inter-operability with a system in which only the low bandwidth hops are used.

### BRIEF DESCRIPTION OF THE DRAWING FIGURES

FIG. 1 is a diagram illustrating the low and high bandwidth hops;

FIG. 2 is a diagram illustrating the low and high bandwidth hops within a bandwidth range;

FIG. 3 is a flowchart of one embodiment of a method of the present invention;

FIG. 4 is a diagram of a transmitter using one embodiment of the present invention;

FIG. 5 is a diagram of a receiver of one embodiment of the present invention;

### DETAILED DESCRIPTION OF THE INVENTION

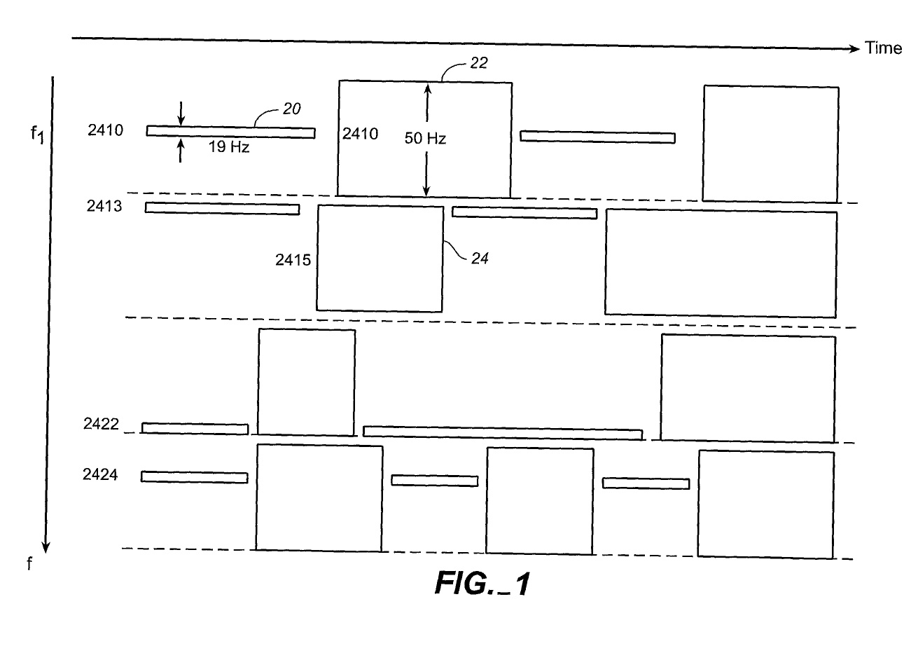

FIG. 1 illustrates the transmission of the low bandwidth hops 20 and the high bandwidth hops 22 within a certain time. In ONE embodiment, the low bandwidth hops 20 have a 1 MHZ bandwidth and the high bandwidth hops 22 have a 5 MHZ bandwidth. By switching on the high bandwidth hops, a higher data rate can be transmitted using the system. The low bandwidth hops can be used for relatively low data rate transmissions. In many communication system there is a trade-off between bandwidth and distance.

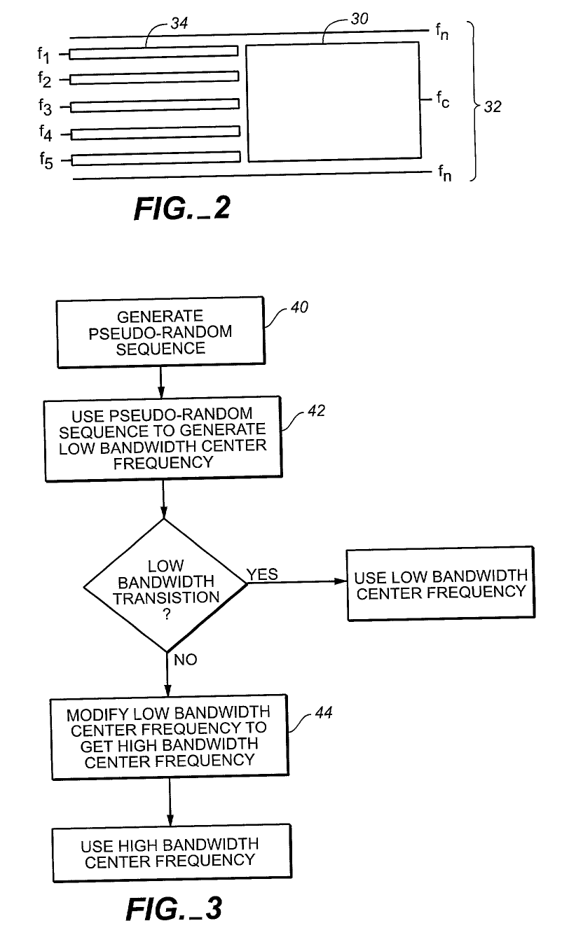

Looking at FIG. 2, since the high bandwidth hop 22 is separated from the potential high bandwidth hop 24, this causes a requirement that they be separated by at least the high bandwidth value in order to avoid overlap. In this example, the center frequency of high bandwidth hop 22 is at 2410 MHZ and potential high bandwidth hop 24 is at 2415 MHZ. The applicants have found that using the same center frequencies for both the high and low frequency hops causes the low frequency hops to be unnecessarily separated. By having more possible low frequency hop center frequencies, improved capacity, better interference immunity and improved backward capability is provided.

FIG. 2 is a diagram illustrating an example in which a wide bandwidth hop 30 is positioned within a first bandwidth range 32. The wide bandwidth hop 30 has a center frequency f_{c}. The narrow bandwidth hop 34 can have a number of center frequencies within the bandwidth range 32. Note that neither the broad bandwidth hop 30 or any of the narrow bandwidth hop 34 expand outside of the frequency range 32. As shown in FIG. 1, a number of different possible ranges, each with single possible wide bandwidth and multiple possible narrow bandwidth hops can be provided in the spread spectrum system.

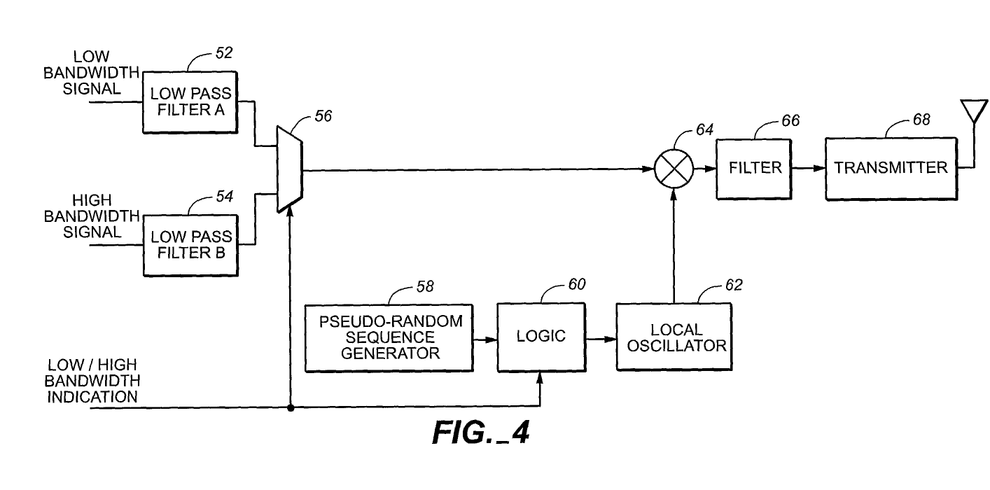

In a preferred embodiment, the same pseudo-random generated sequence is used to create the center frequencies for both the wide bandwidth and narrow bandwidth hops. FIG. 3 illustrates a flow chart of one embodiment of such a system. In step 40, a pseudo-random sequence is created. In step 42, this pseudo-random sequence can be used to determine the low band or center frequency. One way of doing this is to divide the entire spread spectrum bandwidth such that a number of bits of the pseudo-random sequence generation correspond to a specific center frequency for the low bandwidth hops. The same pseudo-random value can be modified to get the high bandwidth center frequency in step 44. An example of how this is done can be shown with respect to FIG. 2. If the pseudo-random sequence points to a center frequency for the low bandwidth hop f₁-f₅, the center frequency f_{c} is used for the high bandwidth hop. The advantage of using the same pseudo-random sequence for the low bandwidth and high bandwidth hop is that it is easier to synchronize the units and multiple pseudo-random sequence generators need not be used in the transmitter and the receivers. FIG. 3 illustrates a system in which first the low bandwidth center frequency is calculated and then later the high bandwidth frequency is determined from this low bandwidth frequency. In an alternate embodiment the sequence can be interpreted in two different manners for low frequency and high frequency transmissions.

FIG. 4 illustrates a transmitter which is used in one embodiment of the present invention. The low bandwidth and high bandwidth signals are produced. Filter 52 filters the low bandwidth signal; filter 54 filters the high bandwidth signal. Different filters are used since the bandpass for the filters would be different for the low and high bandwidth signals. Multiplexer 56 selects whether the low or high bandwidth filter is used. The pseudo-random sequence generator 58 produces a pseudo-random sequence and the logic 60 produces signals to the local oscillator 62 indicative of the center frequency. An indication of whether a high or low bandwidth signal is being transmitted is provided to the logic 60 so that it can produce the correct center frequency. The multiplier 64 and filter 66 up-converts either the low bandwidth or high bandwidth signal. This signal is then transmitted out of the transmitter 68.

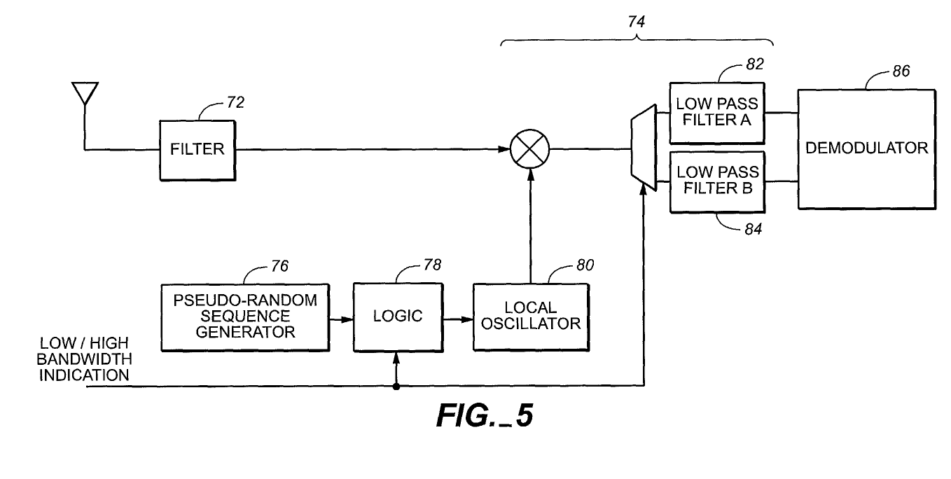

The receiver of one embodiment of the present invention is shown in FIG. 5. The output of a filter 72 is sent to a down-converter unit 74. A pseudo-random generator 76 matches pseudo-random generator of FIG. 4 to produce a sequence which is sent to logic 78 to determine the center frequency of the hop. This value is sent to the local oscillator 80 within the down-converter unit 74. Low-pass filter 82 is used for low bandwidth signals and low-pass filter 84 is used for high bandwidth signals. The down-converted values are sent to a demodulator 86.

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

1. A frequency-hopping wireless communication system, the frequency-hopping wireless communication system using at least two different bandwidth hops at frequency-hopping center frequencies, low bandwidth hops and high bandwidth hop, wherein more center frequencies are available for use for the low bandwidth hops than by the high bandwidth hops.

2. The frequency-hopping wireless communication system of claim 1 wherein the high bandwidth signal defines a first bandwidth range and wherein there is only one possible high bandwidth center frequency within the first bandwidth range and multiple possible low bandwidth center frequencies within the first bandwidth range.

3. The frequency-hopping wireless communication system of claim 1 in which a pseudo-random sequence generator is provided at a transmitter and a receiver.

4. The frequency-hopping wireless communication system of claim 1 wherein the same pseudo-random sequence generator is used for both high and low bandwidth signals.

5. The frequency-hopping wireless communication system of claim 4 wherein a certain pseudo-random sequence generation value corresponds to a different low bandwidth frequency center than high frequency bandwidth center.

6. A frequency-hopping wireless communication system, the frequency-hopping wireless communication system using at least two different bandwidth signals at frequency-hopping center frequencies, low bandwidth hops and high bandwidth hops, wherein a high bandwidth hop defines a first bandwidth range and wherein there is only one possible high bandwidth center frequency within the first bandwidth range and multiple possible low bandwidth center frequencies within the first bandwidth range, the low frequency bandwidth hops at the multiple possible low bandwidth center frequencies not extending out of the first bandwidth range.

7. The frequency-hopping wireless communication system of claim 6 wherein the high frequency bandwidth is an integer number of times larger than the low bandwidth signal.

8. The frequency-hopping wireless communication system of claim 6 wherein a pseudo-random sequence generator is provided at the transmitter and receiver.

9. The frequency-hopping wireless communication system of claim 8 wherein the sequence value which indicates one of the possible low bandwidth center frequencies for a low bandwidth hop also indicates the one possible high bandwidth center frequency for a high bandwidth hop.

10. The frequency-hopping wireless communication system of claim 6 wherein there are multiple bandwidth ranges within the spread spectrum band, each bandwidth range allowing one possible high bandwidth center frequency.
